(19) United States
(12) Patent Application Publication
(10) Pub. No.: US 2018/0034337 A1
(43) Pub. Date: Feb. 1, 2018

(54) ROTARY ELECTRIC MACHINE

(71) Applicant: HITACHI, LTD., Tokyo (JP)

(72) Inventor: Takashi Ishigami, Tokyo (JP)

(73) Assignee: HITACHI, LTD., Tokyo (JP)

(21) Appl. No.: 15/509,932

(22) PCT Filed: Mar. 14, 2016
(86) PCT No.: PCT/JP2016/057889

§ 371 Date: Mar. 9, 2017

(51) Int. Cl. H02K 3/46; H02K 3/12; H02K 9/19; H02K 1/18; H02K 3/28; H02K 15/04; H02K 1/14

(52) U.S. Cl. CPC H02K 3/46; H02K 15/0414; H02K 3/12; H02K 1/148; H02K 1/185; H02K 3/28; H02K 9/19; H02K 2203/12

(57) ABSTRACT

The present disclosure generally relates to a rotary electric machine having a stator winding in which bobbins forming a coil are arranged in a circumferential direction. The bobbin includes plate-like flanges on an inner and outer circumferential side. Each flange has edges corresponding to a circumferential and an axial direction. One or more plate-like members form two or more groove portions in a radial direction in parallel with the flanges between the flanges provided on the inner and outer circumferential sides. The coil includes an electric wire wound around the groove portion between the flange and the plate-like member and the groove portion between adjacent plate-like members. As such, the electric wires can be wound in an aligned manner between the plate-like members. Also, slot space factor is improved, coil end is reduced, and output and efficiency of the rotary electric machine is improved.

### TECHNICAL FIELD

The present invention relates to a rotary electric machine including a stator having a small number of slots, such as 2, 3 or 6.

### BACKGROUND ART

There are demands for the development of a technique for reducing CO₂ emissions to suppress global warming. Therefore, there is a high expectation for enhancing output and efficiency of motors and generators as drive sources.

FIG. 1 illustrates one example of an inner configuration of a rotary electric machine 1. A stator 3 is fixed to an inner circumference of a housing 2 through shrink-fitting or press-fitting. The stator 3 illustrated in FIG. 1 adopts a “concentrated winding” in which a coil 4 is wound around a magnetic pole of a stator core in a concentrated manner.

A rotor core (not shown) having a permanent magnet 5 attached to an outer circumferential portion is inserted to an inner circumference of the stator 3, and a shaft 6 integrated coaxially with the rotor core is supported by a bearing 7. A rotor 8 illustrated in FIG. 1 adopts a “Surface Permanent Magnet” (SPM), but other types of rotors can be used, such as a rotor adopting an “Interior Permanent Magnet” (IPM) in which a magnet is embedded in a groove of the rotor core.

Further, the rotary electric machine illustrated in FIG. 1 is a three-phase machine, and in a state where voltages of different phases (U-phase, V-phase, and W-phase) are respectively applied to three input terminals 9, current flows to the coil 4 within the stator 3 electrically connected to the input terminals. Thereby, electric energy is converted to mechanical energy and the rotor 8 is rotated.

If a cross-sectional area of a conductor constituting the coil 4 of the stator 3 for the rotary electric machine can be increased, the electric resistance of the coil 4 is reduced, and the output and efficiency of the rotary electric machine is increased. Further, if a coil end 10 as a portion of the coil protruding in an axial direction at an outer portion of the stator core is shortened, the electric resistance of the coil 4 is reduced, and the output and efficiency of the rotary electric machine is increased. Therefore, as a ratio of cross-sectional area of the conductor within the slot of the stator increases, and as the length of the coil end minimizes, the output and efficiency of the rotary electric machine will be increased.

Now, a stator having a small number of slots, such as 2, 3 or 6, is used in the rotary electric machine applied to a starter of an automobile, an electric tool, or household electric appliances such as a vacuum cleaner. FIG. 2 is a view illustrating one example of a stator 3 for a starter, wherein the number of slots is 6 (and a number of poles of a rotor not shown is 4). A resin bobbin 12 formed for example of PBT (Poly Butylene Terephthalate) is attached to a metallic teeth 11 formed for example of SUS (Stainless Steel), a coil 4 is wound around the periphery of the teeth, and six of such teeth are aligned in the circumferential direction and screwed onto the housing 2 formed of metal.

The stator having a small number of teeth as described has the following drawbacks.

FIG. 3 illustrates three orthographic views of the bobbin 12 used in the above-described stator 3. As illustrated, in a state where the number of teeth is small, flanges 13 of the bobbin 12 provided at inner and outer circumferences in the radial direction are arc shaped along the circumferential direction of the rotary electric machine. As an example, in a state where an electric wire 14 having a conductor diameter of 1.3 mm (outer diameter including coating: 1.4 mm) multiplied by triple-line configuration is wound around the bobbin 12 for eight turns (total of 24 turns), an ideal electric wire arrangement maintaining alignment is as illustrated in an arrangement plan illustrated in FIG. 4. However, actually, the electric wire 14 cannot be wound around in the manner illustrated in FIG. 4. This is because the crossover wire interferes by the inclination of the surface onto which the wire is wound around (specifically, the influence of interference between the crossover wire and the flange on the inner circumferential side of the bobbin is significant). In a worst case, as illustrated in FIG. 5, the electric wire 14 crosses at right angles with a rotating shaft 16 of the bobbin 12, and attempts to wind on an outer side than a surface A-A in contact with the flange 13 on the inner circumferential side. Therefore, all the electric wires 14 extending over the coil end (short edge of the bobbin) 10 of all coils pass an area outside a surface A-A, and the height of the coil end is as high as 17.1 mm or higher. In the worst case, the number of electric wires 14 that can be arranged within the slot is increased to 22, and a slot space factor (total conductor area including coating×100/effective space of wirings within slot) is deteriorated to 45.5%, compared to 54.9% in the case of the ideal electric wire arrangement.

As described, according to the stator of a rotary electric machine in which the number of teeth is small, the space in which the electric wire can be wound around is curved, and alignment winding cannot be performed, such that the following problems occur; (1) the end coil height is increased, and (2) the predetermined number of electric wires cannot be arranged within the slot.

### CITATION LIST

### Patent Literature

### [PTL 1] Japanese Unexamined Patent Application Publication No. 2008-92692

### SUMMARY OF INVENTION

### Technical Problem

The present invention aims at providing a stator having a small number of teeth, in which the alignment of the electric wire is maintained, the slot space factor is improved, and the coil end is reduced.

### Solution to Problem

The rotary electric machine according to the present invention includes a stator winding in which a plurality of bobbins forming a coil are arranged in a circumferential direction, wherein the bobbin includes plate-like flanges provided on an inner circumferential side and on an outer circumferential side, each flange having edges corresponding to a circumferential direction and an axial direction, and one or more plate-like members forming two or more groove portions in a radial direction in parallel with the flanges between the flanges provided on the inner circumferential side and on the outer circumferential side, and wherein the coil includes an electric wire wound around the groove portion provided between the flange and the plate-like member and the groove portion provided between adjacent plate-like members.

### Advantageous Effects of Invention

According to the present invention that allows electric wires to be wound around in an aligned manner between plate-like members, the slot space factor is improved, the coil end is reduced, and the output and efficiency of the rotary electric machine is improved compared to the conventional technique.

### BRIEF DESCRIPTION OF DRAWINGS

FIG. 1 is a view illustrating one example of an internal configuration of a general rotary electric machine.

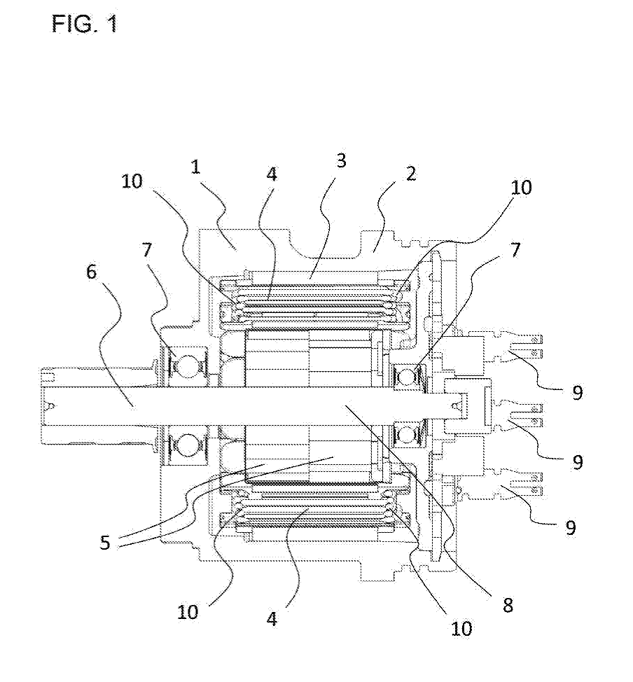

FIG. 2 is a view illustrating one example of a stator of a rotary electric machine having a small number of teeth.

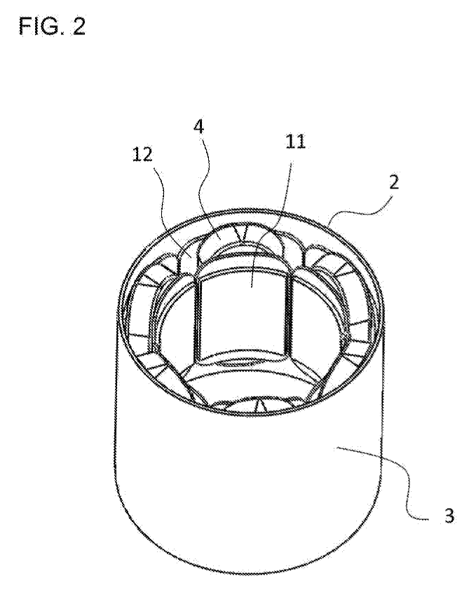

FIG. 3 is a view illustrating a conventional bobbin used in the rotary electric machine having a small number of teeth.

FIG. 4 is a view illustrating an ideal winding arrangement with respect to a conventional bobbin.

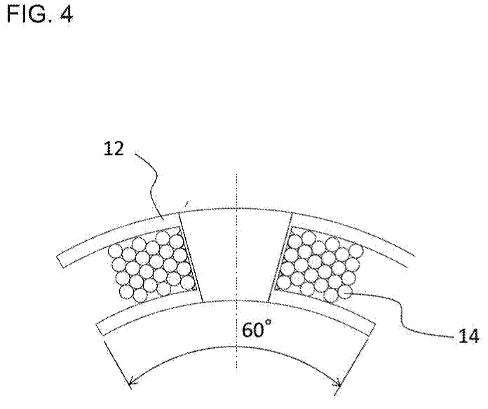

FIG. 5 is a view illustrating a worst arrangement assumed during actual winding operation of the conventional bobbin.

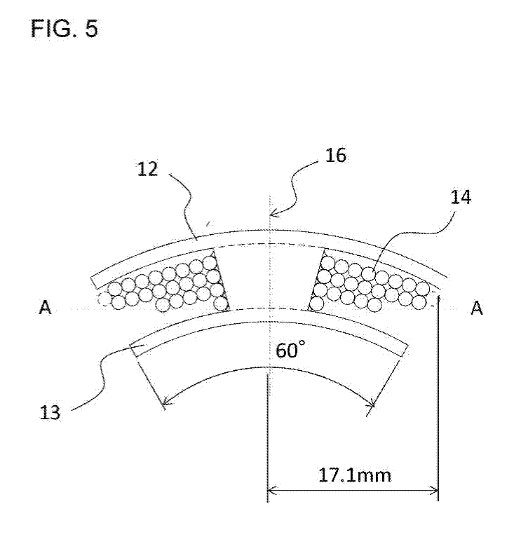

FIG. 6 is a view illustrating a bobbin used in a first embodiment.

FIG. 7 illustrates four orthogonal views of the bobbin used in the first embodiment.

FIG. 8 is an explanatory view illustrating an order of winding of wire with respect to the bobbin used in the first embodiment.

FIG. 9 is a view illustrating a winding arrangement realized according to the first embodiment.

FIG. 10 is a perspective view of a stator formed by the bobbin used in the first embodiment.

FIG. 11 is a view in which the stator formed of the bobbin used in the first embodiment is viewed from an upper side in an axial direction.

FIG. 12 is a view illustrating a winding arrangement according to a second embodiment.

FIG. 13 is a view illustrating winding arrangements according to the first and second embodiments.

FIG. 14 is a view illustrating a bobbin used in a third embodiment.

FIG. 15 is a view illustrating the bobbin used in the third embodiment from an axial direction.

FIG. 16 is an explanatory view illustrating an order of winding of wire with respect to the bobbin used in the third embodiment.

### DESCRIPTION OF EMBODIMENTS

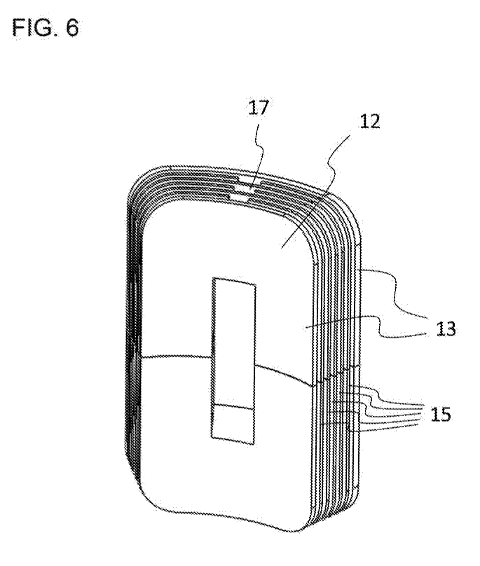

Now, first to third embodiments according to the present invention will be described in the named order with reference to FIGS. 6 through 11.

### Embodiment 1

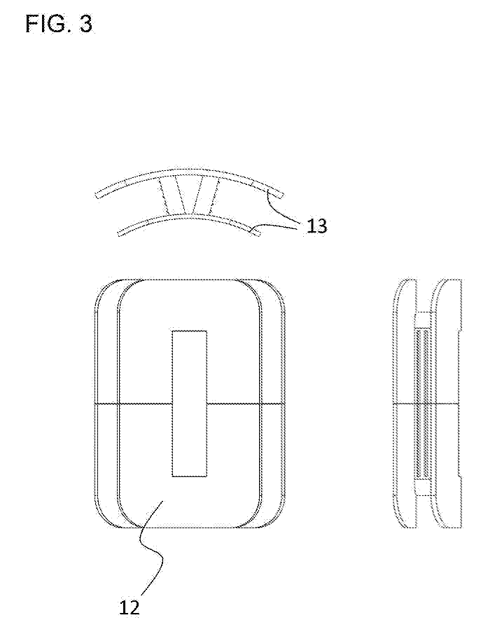

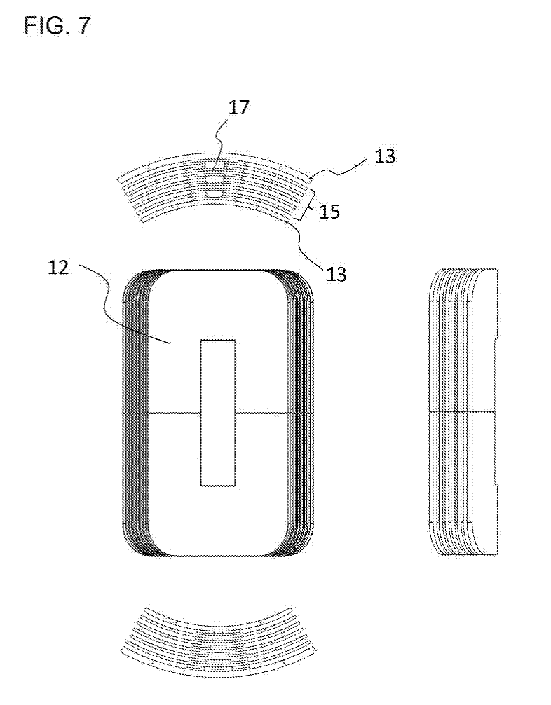

FIG. 6 illustrates a bobbin 12 adopted in a first embodiment according to the present invention. Further, FIG. 7 illustrates four orthogonal views of the bobbin 12. The circumference configuration of the bobbin 12 is set to adopt the same configuration as the bobbin 12 illustrated in FIG. 3 referred to in the background art, to enable comparison of the effect of the invention.

In the first embodiment, one or more plate-like members 15 are provided between the flanges 13 disposed on inner and outer circumferences of the bobbin 12 and each flange having four edges in a circumferential direction and an axial direction of the bobbin 12, the plate-like members 15 arranged in a radial direction in parallel with the flanges 13 (according to the example illustrated in FIGS. 6 through 9, the number of plate-like members 15 is five). Thereby, curved groove portions are formed between the flanges 13 and the plate-like members 15, and between adjacent plate-like members 15. In this example, a thickness of each plate-like member 15 is t 0.45 mm. Notches 17 are formed on a portion of the plate-like member 15 at one edge of the bobbin 12 corresponding to a coil end. In a state where there are multiple plate-like members 15, the notches 17 are provided alternately in the radial direction, as illustrated in FIGS. 6 through 8.

In order to realizes an electrical performance equivalent to a winding having a conductor diameter of 1.3 mm (outer diameter including coating: 1.4 mm) and 24 turns (triple lines multiplied by 8 turns) as described in the background art (in order to set the cross-sectional area per turn to the same value), electric wires having a conductor diameter of 0.75 mm (outer diameter including coating: 0.85 mm) are wound around for 72 turns (triple-line configuration×triple-line configuration×8 turns) around the bobbin 12 of the first embodiment.

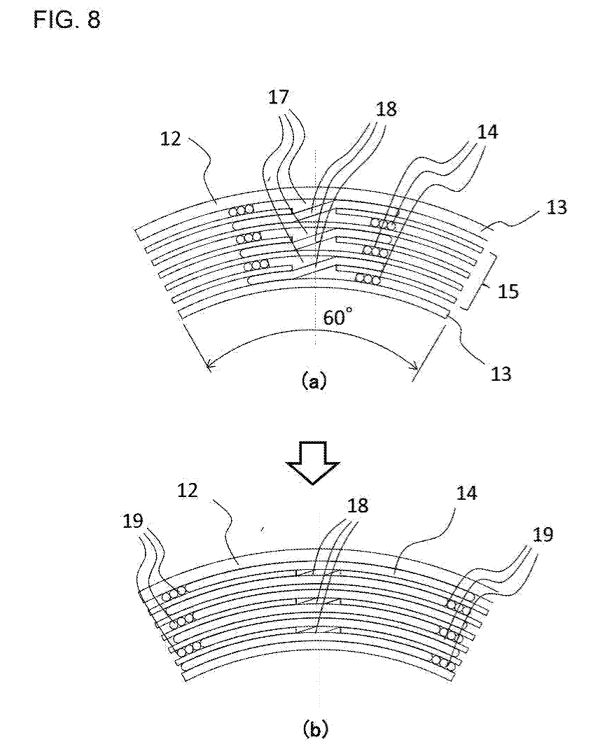

FIG. 8 illustrates a winding order of the winding according to the first embodiment. As illustrated in FIGS. 8A and 8B, triple lines of electric wires 14 having a conductor diameter of 0.75 mm are wound around two grooves formed by the flange 13 and the plate-like member 15 or adjacent plate-like members 15 and arranged adjacent one another in the circumferential direction. Notches 17 are provided on the plate-like members 15 positioned between two grooves adjacent one another in the circumferential direction, and the notches 17 are set as starting points of coils 18, to perform four turns of winding in a counterclockwise direction in inner-side grooves, and four turns of winding in a clockwise direction in outer-side grooves. FIG. 8A illustrates a state in which triple lines of electric wires having a conductor diameter of 0.75 mm are wound around the respective grooves for a single turn, and FIG. 8B illustrates a state in which winding of four turns have been completed. In this case, the terminal wires 19 of the coil are all arranged on an outer circumferential side of the coils, and a circuit of triple lines multiplied by triple lines is configured by bundling nine terminal wires 19 at a side surface of the same coil.

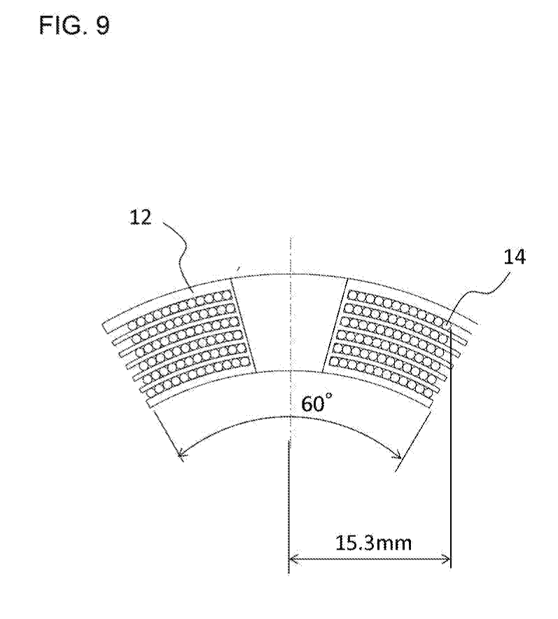

FIG. 9 illustrates a winding arrangement plan after completing winding. According to the bobbin structure utilized in the first embodiment, all the electric wires 14 with a conductor diameter of 0.75 mm multiplied by triple lines multiplied by triple lines multiplied by 8 turns, which has an equivalent cross-sectional area as the wires with a conductor diameter of 1.3 mm multiplied by triple lines multiplied by 8 turns, can be stored in an aligned manner within the grooves in a space capable of storing a winding with a circumferential direction of 60 degrees.

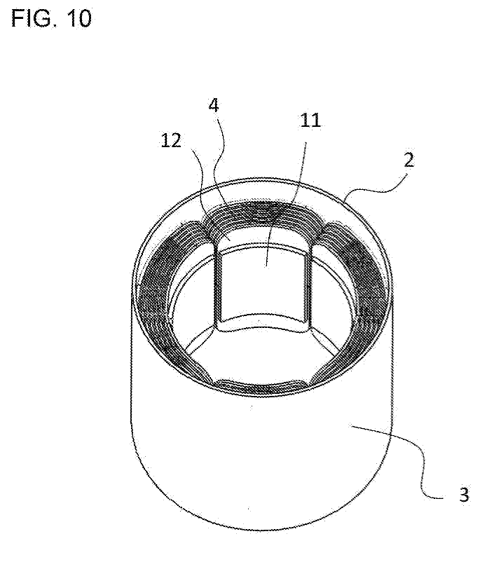

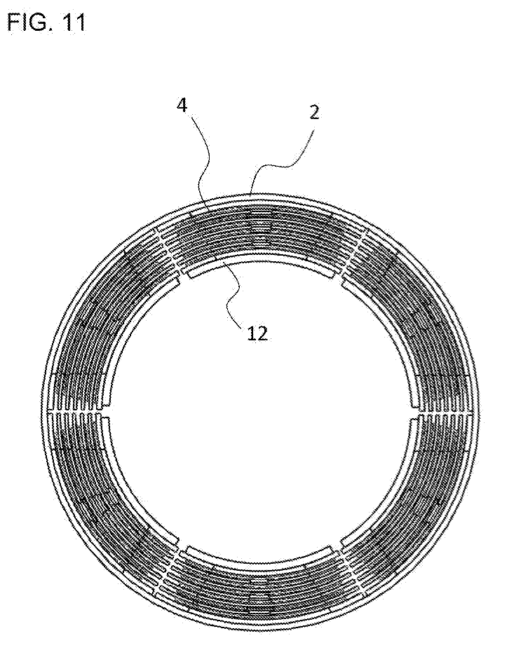

FIG. 10 is a perspective view of the stator 3 to which is assembled the coil wound around the bobbin 12 used in the first embodiment. Further, FIG. 11 is a view in which the stator is viewed from an upper side in the axial direction. As a result, the coil end height can be set to 15.3 mm (which, according to the prior art, was 17.1 mm or greater, as described earlier), as illustrated in FIG. 9. Further, the slot space factor can be increased to 54.9%, which is equivalent to a case in which all 24 electric wires having a conductor diameter of 1.3 mm are stored (which, according to the prior art, was 44.5% with 22 wires in the worst case).

### Second Embodiment

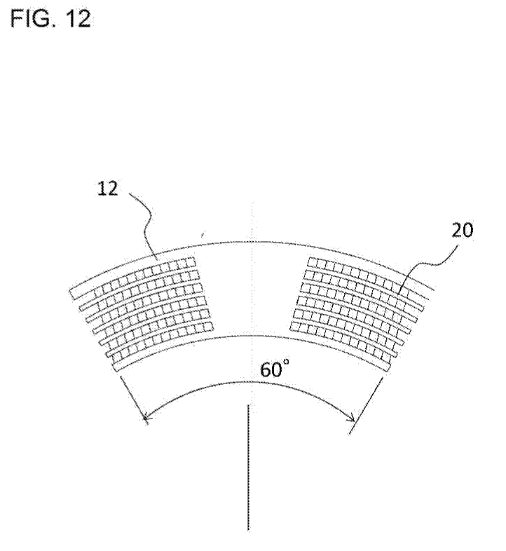

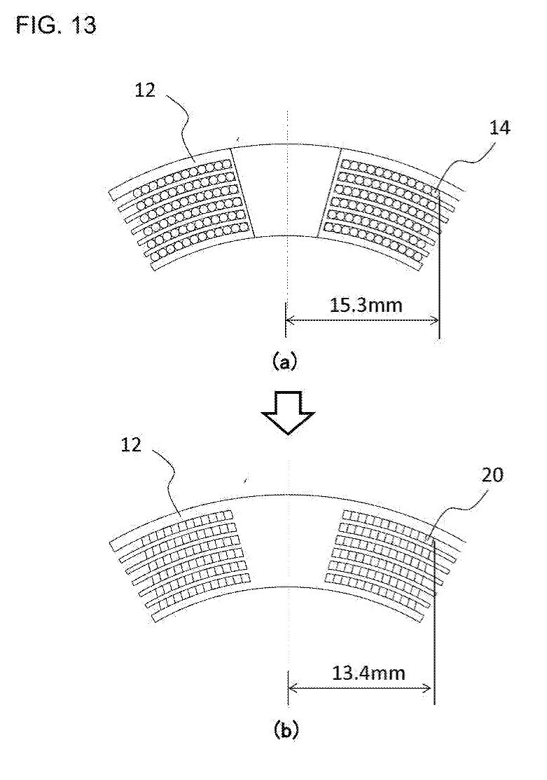

A second embodiment of the present invention will be described with reference to FIGS. 12 and 13. In the second embodiment, electric wires 20 having a rectangular cross-section are used instead of electric wires 14 having a round cross-section used in the first embodiment. Thereby, the effect of the present invention can be enhanced even further.

FIG. 12 is an arrangement plan of winding after completing the winding process. If the electric wire 20 having a rectangular cross-section adopts a conductor diameter having a 0.75 mm square cross-section and a corner R of 0.3 mm, a cross-sectional area of the conductor is improved by 11% and an ohmic loss (heat loss) of the coil is reduced by 10%, compared to a case in which the electric wire 14 having a round cross-section and a conductor diameter of 0.75 mm is used, with the coil end height unchanged.

Further, in a case where an electric wire 20 having a rectangular cross-section adopting a conductor having a cross-sectional dimension of 0.75 mm multiplied by 0.68 mm and a corner R of 0.3 mm having the same cross-sectional area as a copper wire having a conductor diameter of 0.75 mm is used, as illustrated in FIG. 13, the coil end height can be further reduced from 15.3 mm (FIG. 13A) to 13.4 mm (FIG. 13B) with the electric performances unchanged.

### Third Embodiment

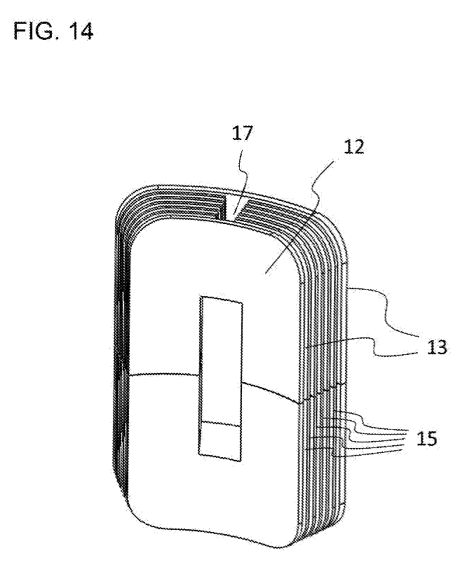

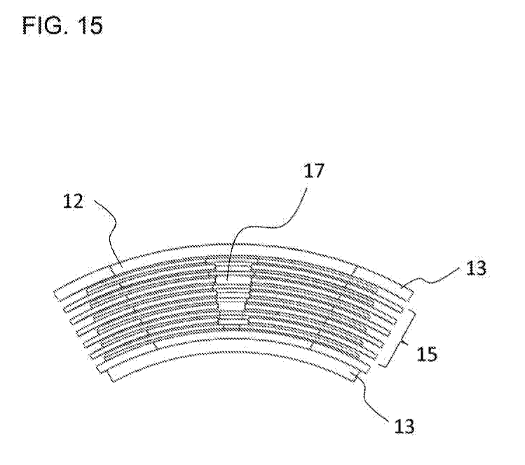

A third embodiment of the present invention will be described with reference to FIGS. 14 through 16. FIG. 14 is a view illustrating a configuration of the bobbin 12 used in the third embodiment. What differs from the first embodiment is that the notch 17 formed on the plate-like members 15 of the coil end passes through all the plate-like members 15 in the radial direction. FIG. 15 is a view in which the bobbin 12 of the third embodiment is seen from the axial direction.

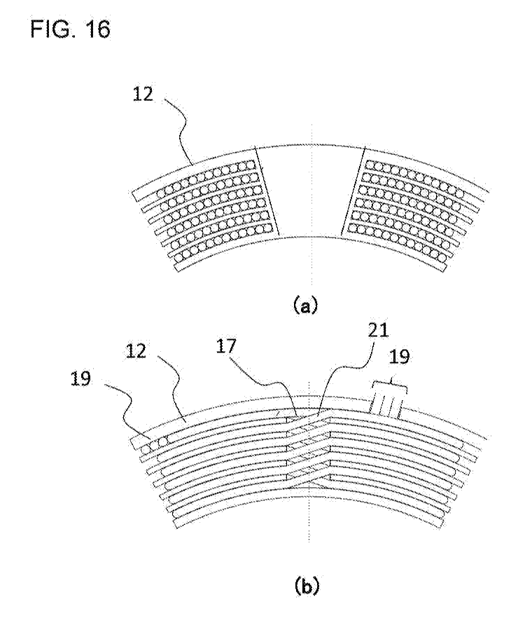

According to the bobbin having the conventional configuration, if a case is considered in which an electric wire having a conductor diameter of 1.3 mm (outer diameter including coating: 1.4 mm) is wound around for 24 turns (unlike the first embodiment, the electric wire is wound around in a line without adopting a multiple line configuration), the coil end height will be 17.1 mm or greater, and the slot space factor will be 45.5% in the worst case, similar to the case described in the Background Art. However, in a case where the bobbin 12 according to the third embodiment is used as illustrated in FIG. 16A, 24 turns of electric wire 14 can be stored within the slot with a conductor diameter of 0.75 mm multiplied by triple lines. Thereby, the coil end can be reduced to 15.3 mm from the conventional 17.1 mm, and the slot space factor can be improved to 54.9% from the conventional 45.5%.

Since the 24 turns of electric wire 14 is continuous from the start of winding to the end of winding, as illustrated in FIG. 16B, the electric wire adopting the triple-line configuration is transferred from one groove to an adjacent groove at the notch 17 passing through the plate-like members in the radial direction. For each layer in which triple-lines of electric wires are wound in a reciprocating manner in the axial direction, a direction of inclination of a crossover wire 21 at the transfer portion differs, such that the wires are arranged in an intersected manner for each layer.

As described, the present invention enables to improve alignment of coils used in the stator of a rotary electric machine having a small number of teeth, and to realize a rotary electric machine having a short coil end and a high slot space factor.

### REFERENCE SIGNS LIST

1 rotary electric machine, 2 housing, 3 stator, 4 coil, 5 permanent magnet, 6 shaft, 7 bearing, 8 rotor, 9 input terminal, 10 coil end, 11 teeth, 12 bobbin, 13 flange, 14 electric wire (round cross-section), 15 plate-like member, 16 rotating shaft, 17 notch, 18 starting point of coil, 19 terminal wire, 20 electric wire (rectangular cross-section), 21 crossover wire

1. A rotary electric machine comprising a stator winding in which a plurality of bobbins forming a coil are arranged in a circumferential direction,
wherein the bobbin comprises plate-like flanges provided on an inner circumferential side and on an outer circumferential side, each flange having edges corresponding to a circumferential direction and an axial direction, and
one or more plate-like members forming two or more groove portions in a radial direction in parallel with the flanges between the flanges provided on the inner circumferential side and on the outer circumferential side, and
wherein the coil comprises an electric wire wound around the groove portion provided between the flange and the plate-like member and the groove portion provided between adjacent plate-like members.

2. The rotary electric machine according to claim 1,
wherein the electric wire is wound in a line around each groove portion.

3. The rotary electric machine according to claim 1,
wherein a notch is formed on a portion of an edge of the plate-like member.

4. The rotary electric machine according to claim 3,
wherein the notch is arranged alternately in a radial direction, in a state where there are a plurality of plate-like members.

5. The rotary electric machine according to claim 3,
wherein the notch is penetrated in a radial direction.

6. The rotary electric machine according to claim 1,
wherein the electric wire includes a wire having a rectangular cross-sectional shape.
